(19) United States
(12) Patent Application Publication
(10) Pub. No.: US 2010/0314533 A1
(43) Pub. Date: Dec. 16, 2010

(54) SCANNING MICROSCOPE AND METHOD OF IMAGING A SAMPLE

(75) Inventors: Sjoerd Stallinga, Eindhoven (NL); Bas Hulsken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/809,355

(22) PCT Filed: Dec. 18, 2008
(86) PCT No.: PCT/IB2008/055411

§ 371 Date: Jun. 18, 2010

(30) Foreign Application Priority Data
Dec. 21, 2007 (EP) 07301735.2

(51) Int. Cl. G02B 21/36

(52) U.S. Cl. 250/234

(57) ABSTRACT

The invention relates to a method of imaging a sample with a scanning microscope and an imaging system for a scanning microscope, comprising the steps of: initiating an exposure phase of a detector (34) by a pulsed laser source (12); generating an optical image of the sample on the detector with a lens system (32); and terminating the exposure phase. According to the invention, the step of generating the optical image comprises a step of displacing the optical image on the detector with an image displacement means (40) between two consecutive laser pulses. The image displacement means comprise a rotatable mirror (40) situated on an optical path from the sample (26) to the detector (34).

### FIELD OF THE INVENTION

The invention relates to a method of imaging a sample with a scanning microscope, comprising the steps of:

initiating an exposure phase of a detector;

generating an optical image of the sample on the detector; and

terminating the exposure phase.

The invention also relates to an imaging system for a scanning microscope, the imaging system comprising:

a detector;

a lens system for generating on the detector an optical image of a sample; and

image displacement means for displacing the optical image on the detector during an exposure phase of the detector.

The invention further relates to a scanning microscope comprising an imaging system as specified above.

### BACKGROUND OF THE INVENTION

Optical scanning microscopy is a well-established technique for providing high resolution images of microscopic samples. According to this technique, one or several distinct, high-intensity light spots are generated in the sample. Since the sample modulates the light of the light spot, detecting and analyzing the light coming from the light spot yields information about the sample at that light spot. A full two-dimensional or three-dimensional image of the sample is obtained by scanning the relative position of the sample with respect to the light spots. The technique finds applications in the fields of life sciences (inspection and investigation of biological specimens), digital pathology (pathology using digitized images of microscopy slides), automated image based diagnostics (e.g. for cervical cancer, malaria, tuberculosis), and industrial metrology.

A light-spot generated in the sample may be imaged from any direction, by collecting light that leaves the light spot in that direction. In particular, the light spot may be imaged in transmission, that is, by detecting light on the far side of the sample. Alternatively, a light spot may be imaged in reflection, that is, by detecting light on the near side of the sample. In the technique of confocal scanning microscopy, the light spot is customarily imaged in reflection via the optics generating the light spot, i.e. via the spot generator.

U.S. Pat. No. 6,248,988 proposes a multispot scanning optical microscope featuring an array of multiple separate focussed light spots illuminating the object and a corresponding array detector detecting light from the object for each separate spot. Scanning the relative positions of the array and object at slight angles to the rows of the spots then allows an entire field of the object to be successively illuminated and imaged in a swath of pixels. Thereby the scanning speed is considerably augmented.

The array of light spots required for this purpose is usually generated from a collimated beam of light that is suitably modulated by a spot generator so as to form the light spots at a certain distance from the spot generator. According to the state of the art, the spot generator is either of the refractive or of the diffractive type. Refractive spot generators include lens systems such as micro lens arrays, and phase structures such as the binary phase structure proposed in WO 2006/035393.

The speed at which the sample is scanned through the sample is generally chosen constant. A non-uniform speed is difficult to implement and may lead to undesired vibrations of the sample assembly. The photodetector having a non-negligible exposure time, the scanning speed must not be too large. Otherwise motion blur on the photodetector would provoke a loss in resolution along the scanning direction. Indeed, every photodetector records light during a so-called exposure phase. At the end of the exposure phase, the recorded light distribution is read out and a new exposure phase is initiated. A complete cycle consisting of an exposure phase and a read-out phase is also called a frame. The number of distinct images the photodetector may record during a given time interval is referred to as the detector's frame rate. If the sample moves with respect to a light spot during the exposure phase, the light spot's image that is recorded on the photodetector will be the result of the interactions between the light spot and all those segments of the sample that were scanned through the light spot during the detector's exposure phase. Thus different segments of the sample are imaged onto the same spot on the photodetector. Clearly, it would be desirable to image them onto different areas on the photodetector, however without reducing the scanning speed.

Motion blur can be effectively eliminated by a pulsed illumination of the sample or by adjusting the image sensor to collect only photoelectrons during a part of each frame. However, these measures require additional electronic control means and do not solve the trade-off between throughput and resolution. Moreover, they can result in a lower amount of light that is collected during the frame, implying a lower signal level.

It is therefore an object of the present invention to provide means and methods for imaging a sample with a scanning microscope, wherein the throughput is increased as compared to the state of the art. In particular, it is an object of the invention to increase the scanning speed, given a maximum permissible amount of motion blur, or, equivalently, to reduce motion blur for a given scanning speed.

Some important remarks apply to the use of the word “image” in this application. An “optical image” is understood to be an image produced on an image plane by an optical lens system of an object if the object were evenly illuminated. Thus it is possible to speak of an optical image generated by the lens system, irrespective of the actual way in which the object is illuminated. Hence an optical image as defined here is a theoretical image that helps to describe an optical system or use of an optical system. In contrast, a “recorded image” is understood to be an image physically registered on an image plane, in particular the image registered on the photodetector. A “digital image” is defined as a digital code containing information about an image.

### SUMMARY OF THE INVENTION

According to the invention, the method of imaging a sample with a scanning microscope is characterized in that the step of generating the optical image comprises a step of displacing the optical image on the detector. The detector may in particular be a photodetector. The invention thus teaches to shift the sample's optical image laterally across the photodetector, wherein it is implicitly understood that the image is not significantly resized or distorted during the shifting process. Additionally, the optical image might also be rotated with respect to the photodetector. By displacing the optical image on the photodetector during an exposure phase of the photodetector, motion blur can be reduced, because light from spatially separated points of the sample is then collected at different detector elements. More precisely, light emitted at consecutive moments from a certain light spot in the sample is collected at different pixels or segments of the photodetector, each pixel or segment corresponding to one of the consecutive moments and thus to the portion of the sample that was illuminated during that moment. In an analysis performed after the exposure phase, it is then possible to distinguish different portions of the sample that were illuminated by the same light spot during the preceding exposure phase. In a multispot scanning microscope embodiment, instead of an array of spots, the overall image recorded on the photodetector is an array of straight or curved lines if the illumination of the sample is continuous during each exposure phase, or a plurality of N mutually displaced arrays of spots if the sample is illuminated by a series of N short pulses during the exposure phase. In the latter case the resolution in the scanning direction is improved to v/f/N where v is the scanning speed and f the frame rate, or alternatively, for a given resolution, the throughput is increased by a factor of N.

The optical image may be displaced on the detector by modifying the properties of the imaging optics between the sample and the detector, in particular by moving elements such as lenses or mirrors. Alternatively or additionally the detector may be displaced with respect to the sample assembly.

According to one embodiment, the step of displacing the optical image comprises a step of displacing the optical image on the photodetector along a straight line. Preferably the optical image is displaced along the straight line forth and back. More precisely, the optical image may be displaced continuously along the straight line in a forward direction during a first exposure phase of the photodetector. After the first exposure phase and after initiating a second exposure phase, the optical image may be continuously displaced along the same straight line in a backward direction. The procedure may be repeated, resulting in a cyclic motion of the optical image on the photodetector. Preferably the cyclic motion is periodic.

According to another embodiment, the step of displacing the optical image comprises a step of displacing the optical image on the photodetector along an arc of a circle. The arc of the circle may in particular be an entire circle.

Preferably, the step of displacing the optical image comprises a step of displacing the optical image on the photodetector along a closed line. The closed line may, for example, be a circle or an ellipse.

Advantageously, the step of displacing the optical image comprises a step of moving a mirror situated on an optical path from the sample to the photodetector. By moving the mirror in a suitable manner, the optical image may be deflected as to produce the desired displacement.

According to a preferred embodiment of the invention, the step of generating an optical image comprises a step of generating a first light spot and a second light spot within the sample, and the step of displacing the optical image is further characterized in that the first light spot generates a first trace on the photodetector and the second light spot generates a second trace on the photodetector such that the trace of the first light spot and the trace of the second light spot do not cross. Thereby it is avoided that a pixel of the photodetector is exposed to both the first light spot and the second light spot during a single exposure period and it is ensured that the effects from the first light spot and from the second light spot can be analyzed separately.

According to a preferred embodiment of the invention, the step of generating an optical image comprises a step of illuminating the sample using light pulses. Assuming that there are N pulses in the exposure phase, these N pulses give rise to N images on the image sensor that are spatially separated, thus increasing the throughput of the scanning microscope by a factor N. Also, compared to a continuous illumination of the sample, motion blur is reduced, provided the duration of each pulse is short compared to the duration of the exposure phase. Furthermore, the intensity of each light pulse can be sufficiently high to avoid underexposure of the photodetector. In fact underexposure could be a problem in the present method when the energy of a light spot collected during the exposure phase is distributed along a line on the photodetector, rather than being concentrated in a small area.

According to the second aspect of the invention, the imaging system for a scanning microscope comprises:

a detector;

a lens system for generating on the detector an optical image of a sample; and

image displacement means for displacing the optical image on the detector during an exposure phase of the detector.

The detector may in particular be a photodetector.
Preferably, the image displacement means are driven by an electric motor.

Preferably, the image displacement means comprise a rotatable mirror situated on an optical path from the sample to the photodetector. With reference to said optical path, the mirror may be either situated between the sample and an objective, or between the objective and the photodetector, or it may be situated between different components of the objective. The mirror may be plane or curved. Preferably it is plane for ease of manufacturing. However, a curved mirror might be advantageously be used to minimize distortions of the optical image when the optical image is displaced on the photodetector. Preferably, the mirror is rotatable in a periodic manner with a frequency adapted to a frame rate of the photodetector. Preferably the frame rate of the photodetector is an integer multiple of the mirror's rotational frequency. Even more preferably the frame rate of the photodetector is one or two times the mirror's rotational frequency.

According to a first embodiment, the mirror's rotational axis and the mirror's optical axis cut each other at a right angle. This arrangement is suited for displacing the optical image along a straight line, preferably in a back and forth manner, as described above with reference to the first aspect of the invention.

According to a second embodiment, the mirror's rotational axis and the mirror's optical axis cut each other at a positive angle of less than 5°. This arrangement is particularly suited for displacing the optical image along a circle, preferably in a uniform manner by rotating the mirror with a constant angular velocity, as described above with reference to the first aspect of the invention.

In accordance with the third aspect of the invention, a scanning microscope comprises an imaging system of the type specified above.

The scanning microscope preferably comprises means for generating an array of light spots within a sample. The means for generating an array of light spots may in particular be an array of apertures, or an array of microlenses, or a binary phase structure.

### BRIEF DESCRIPTION OF THE DRAWINGS

FIG. 1 schematically illustrates a prior art multispot scanning microscope.

FIG. 2 schematically illustrates an array of light spots generated within a sample according to the state of the art.

FIG. 3 schematically shows a multispot scanning microscope according to a first embodiment of the invention.

FIG. 4 schematically illustrates an image recorded on the photodetector in accordance with the embodiment of FIG. 3.

FIG. 5 is a process chart of a method in accordance with the embodiment of FIG. 3.

FIG. 6 schematically shows a multispot scanning microscope according to a second embodiment of the invention.

FIG. 7 schematically illustrates an image recorded on the photodetector in accordance with the embodiment of FIG. 6.

FIG. 8 is a process chart of a method in accordance with the embodiment of FIG. 6.

### DESCRIPTION OF PREFERRED EMBODIMENTS

In the drawings, similar or analogous features appearing in different figures are designated using the same reference numerals and are not necessarily described more than once.

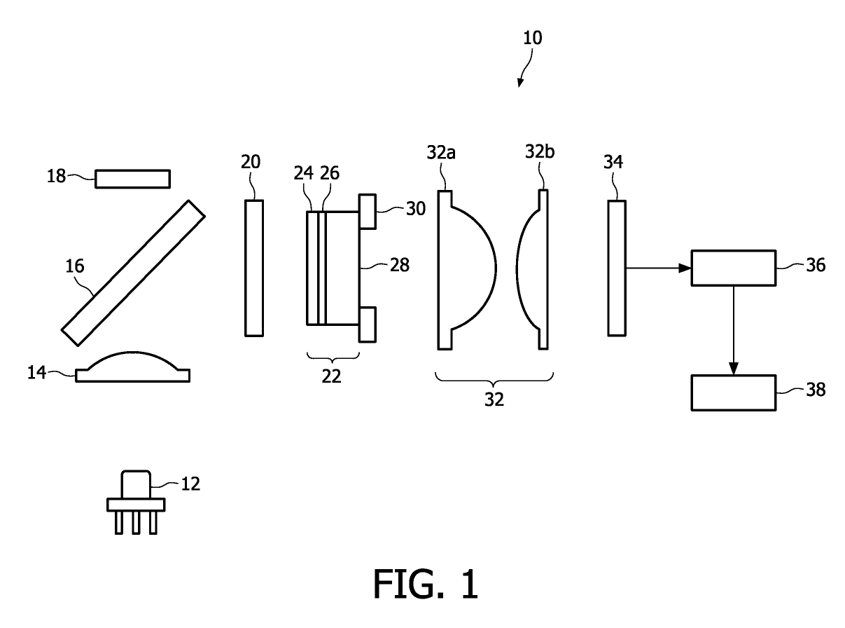

FIG. 1 schematically illustrates a prior art multispot scanning microscope. The microscope comprises a laser 12, a collimator lens 14, a beam splitter 16, a forward-sense photodetector 18, a spot generator 20, a sample assembly 22, a scan stage 30, imaging optics 32, a pixelated photodetector 34, a video processing integrated circuit (IC) 36, and a personal computer (PC) 38. The sample assembly 22 is composed of a cover slip 24, a sample layer 26, and a microscope slide 28. The sample assembly 22 is placed on the scan stage 30 coupled to an electric motor (not shown). The imaging optics 32 is composed of a first objective lens 32a and a second lens 32b for making the optical image. The objective lenses 32a and 32b may be composite objective lenses. The laser 12 emits a light beam that is collimated by the collimator lens 14 and incident on the beam splitter 16. The transmitted part of the light beam is captured by the forward-sense photodetector 18 for measuring the light output of the laser 12. The results of this measurement are used by a laser driver (not shown) to control the laser's light output. The reflected part of the light beam is incident on the spot generator 20. The spot generator 20 modulates the incident light beam to produce an array of light spots in a sample placed in the sample layer 26. It is to be noted here and in the following text, that according to the invention the wording “in the sample” encompasses the meaning of “at the surface of the sample”.

The imaging optics 32 generates on the pixelated photodetector 34 an optical image of the sample layer 26 illuminated by the array of scanning spots. The captured images are processed by the video processing IC 36 to a digital image that is displayed and possibly further processed by the PC 38.

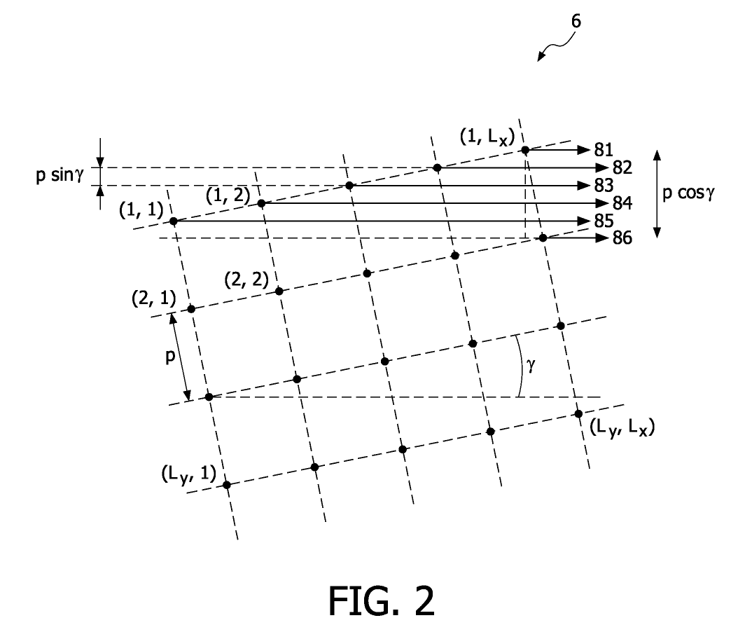

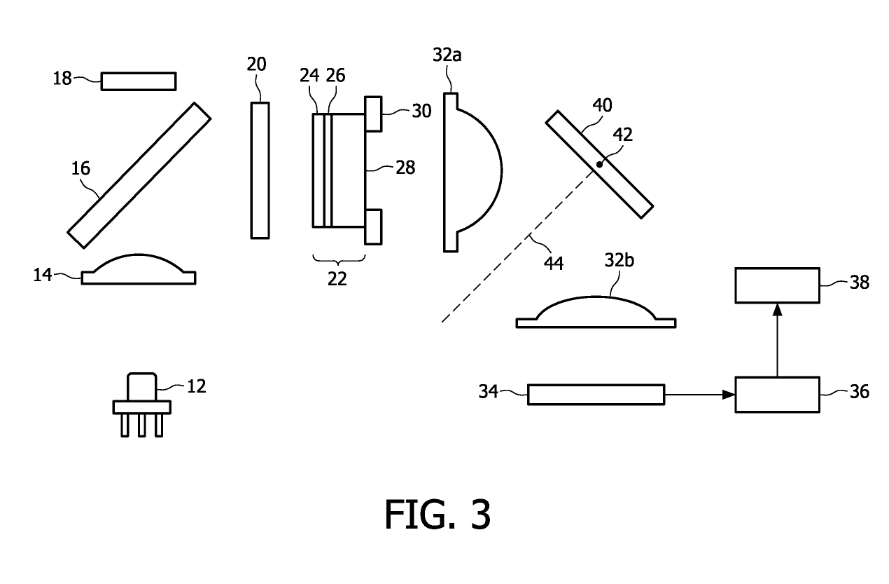

Referring now to FIG. 2, there is shown schematically an array 6 of light spots generated in the sample layer 26 (see FIG. 3). The array 6 is arranged along a rectangular lattice having square elementary cells of pitch p. The two principal axes of the grid are taken to be the x and the y direction, respectively. The array is scanned across the sample in a direction which makes a skew angle γ with either the x or the y direction. The array comprises Lₓ×L_{y} spots labelled (i,j), where i and j run from 1 to Lₓ and L_{y}, respectively. Each spot scans a line 81, 82, 83, 84, 85, 86 in the x-direction, the y-spacing between neighbouring lines being R/2 where R is the resolution and R/2 the sampling distance. The resolution is related to the angle γ by p sin γ=R/2 and p cos γ=Lₓ R/2. The width of the scanned “stripe” is w=LR/2 The sample is scanned with a speed v, making the throughput (in scanned area per time) wv=LRv/2. Clearly, a high scanning speed is advantageous for throughput. However, the resolution along the scanning direction is given by v/f, where f is the frame rate of the image sensor.

Referring now to FIG. 3, there is provided a schematic view of a multispot scanning microscope according to a first embodiment of the invention. The microscope differs from the prior-art microscope of FIG. 1 essentially in that a rotatable plane mirror 40 is placed in between the two lenses 32a and 32b of the imaging optics 32. The optical axis of the two lenses 32a and 32b are now perpendicular to each other. The mirror 40 is oriented such that the light beam from the first composite lens 32a is deflected by about 90° onto the second composite lens 32b. The beam is substantially collimated between the two lenses 32a and 32b. The mirror 40 can pivot about its rotational axis 42 which is perpendicular to the plane of the drawing, where “pivot” means to rotate back and forth. Preferably, the angle describing the mirror's orientation with respect to rotation about its rotational axis 42 only varies by a few degrees, preferably less than 5°. As the mirror 40 pivots about its axis 42, the angle by which the light beam from the first composite lens 32a is deflected oscillates, typically between 88° and 92°. As a result the optical image of the sample layer 26 on the photodetector 34 is laterally shifted back and forth in the direction orthogonal to the axis of rotation 12 of the mirror 40. The laser 12 generates N pulses during every frame of the image sensor 34. The mirror 40 changes its orientation, i.e. its pivot angle, in between two consecutive pulses so that the image of the sample 26 illuminated by the scanning spot array 6 is displaced on the image sensor 34 over a distance equal to the focal length of the second lens 32b times the change in pivot angle. The displacement of the optical image across the image sensor 34 in between two consecutive pulses is chosen substantially larger than the size of the light spots on the sensor 34, so that the signals resulting from consecutive illuminations can be disentangled during processing. Preferably, the pivoting mirror 40 executes a saw tooth-like rotation over time, with a frequency locked to a frame rate of the image sensor 34; that is, the mirror rotates forward, say from 88° to 92°, with a continuous rotational speed during a time length which is an entire multiple of the duration of a frame of the photodetector; then the mirror rotates back, from 92° to 88° in the example, in a negligible amount of time. Alternatively, the back and forth rotation may be symmetric, in the sense that the rotational velocity during the back rotation is the inverse of the rotational velocity during the forward rotation.

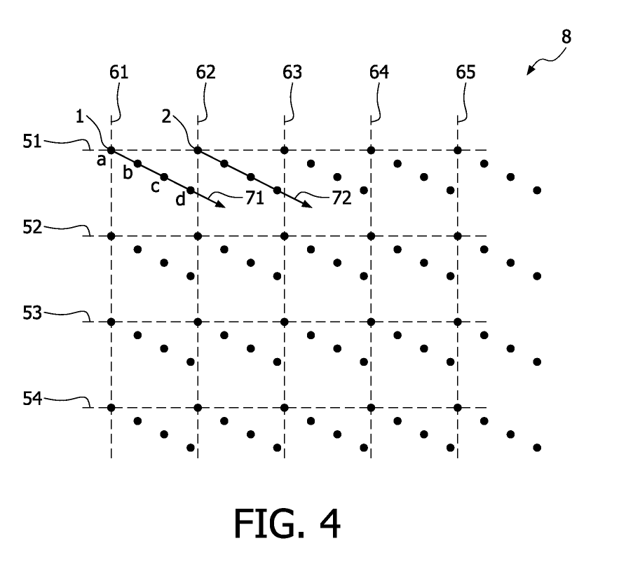

FIG. 4 shows a typical image 8 recorded on the image sensor 34 of FIG. 3. The recorded image 8 is the result of four successive illuminations a, b, c, d giving rise to four spot arrays which are mutually displaced along a straight line, in the direction of lines 71 and 72. It is pointed out that the four rectangular spot arrays recorded on the image sensor are produced successively from a single rectangular spot array generated within the sample via the spot generator 20 of FIG. 3. In particular, a first illumination “a” by a pulse from the laser 12 of FIG. 3 produces a first rectangular array of light spots aligned in rows 51, 52, 53, 54 and columns 61, 62, 63, 64, 65. The array comprises a first recorded light spot 1 and a second recorded light spot 2. As a consequence of varying the orientation of the rotatable mirror 40 of FIG. 3, the first light spot and the second light spot of the array generated in the sample define on the image sensor a first trace 71 and a second trace 72 respectively. Being parallel, the first trace 71 and the second trace 72 do not cross. On the first trace 71 are situated a total of four light spots including the first light spot 1. The four light spots are the result of four successive light pulses emitted from the laser 12 of FIG. 3. If the mirror 40 were immobile, the four light spots would be all registered at the position of the first light spot 1. However, the mirror 40 changing its orientation between consecutive laser pulses, these spots are mutually displaced and can be analyzed separately after the recorded image 8 has been read out from the photodetector 34. Note that the displacement direction of the rectangular spot array on the photodetector 32 is substantially different from the axes of the spot array. In this way a particularly large number of light pulses can be recorded on the photodetector 32 without producing overlapping light spots.

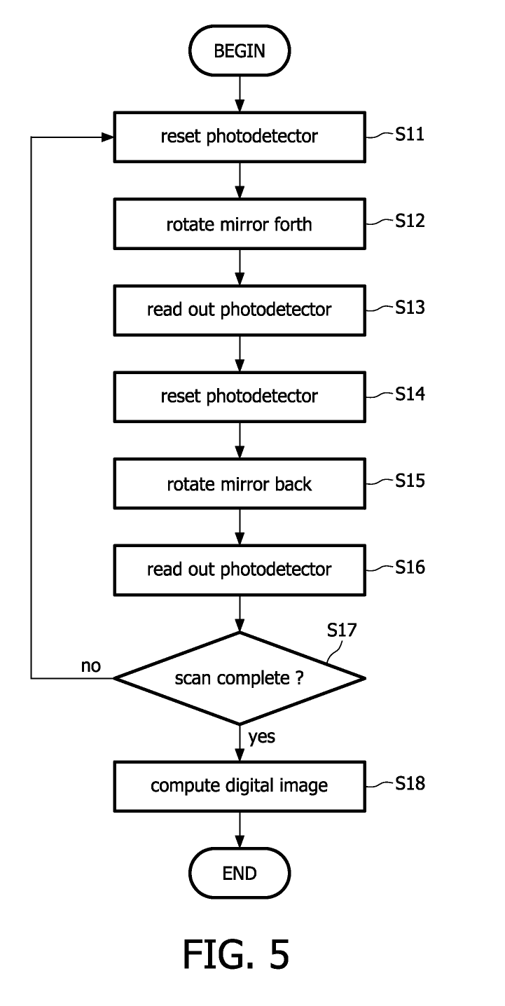

The method of imaging a sample with a scanning microscope according to the first embodiment is further illustrated by the flow chart of FIG. 5. In a first step S11, the photodetector 32 of FIG. 3 is reset to clear any previously recorded image. Thereby an exposure phase of the photodetector is initiated. In a subsequent step S12, the mirror 40 of FIG. 3 is rotated uniformly about its rotational axis 42 by a small angle in a forward sense. During said step S12, the laser 12 of FIG. 13 emits at regular intervals a number of light pulses, each pulse producing, by means of the spot generator 20, an array of the light spots on the photodetector 32 displaced with respect to the arrays recorded previously on the photodetector during the present step S12. In a subsequent step S13, the image which has been recorded on the photodetector during the preceding step S12 is read out from the photodetector and processed by the video processing integrated circuit 36 of FIG. 3. In a subsequent step S14 analogous to step S11 the recorded image is cleared from the photodetector, whereby a new exposure phase of the photodetector is initiated. In a subsequent step S15, the mirror 40 is rotated uniformly about its rotational axis 42 in a backward sense to assume the orientation it had at the beginning of the process, that is, at step S11. In a subsequent step S16, which is analogous to step S13, the recorded image is read out from the photodetector and further processed. Next, in step 17, it is determined whether scanning of the sample is complete. If the scan is found to be complete, a digital image is computed from the accumulated data retrieved from the photodetector during the preceding steps. Otherwise the scanning cycle comprising steps S11 to S17 is repeated. According to a different albeit related embodiment, steps S14 and S16 may be replaced by an alternative step (not shown) of rotating the mirror back to its initial orientation in an amount of time which is short compared to the amount of time needed for carrying out steps S11 to S13, whereby the alternative step merely serves to return to the starting point of the process.

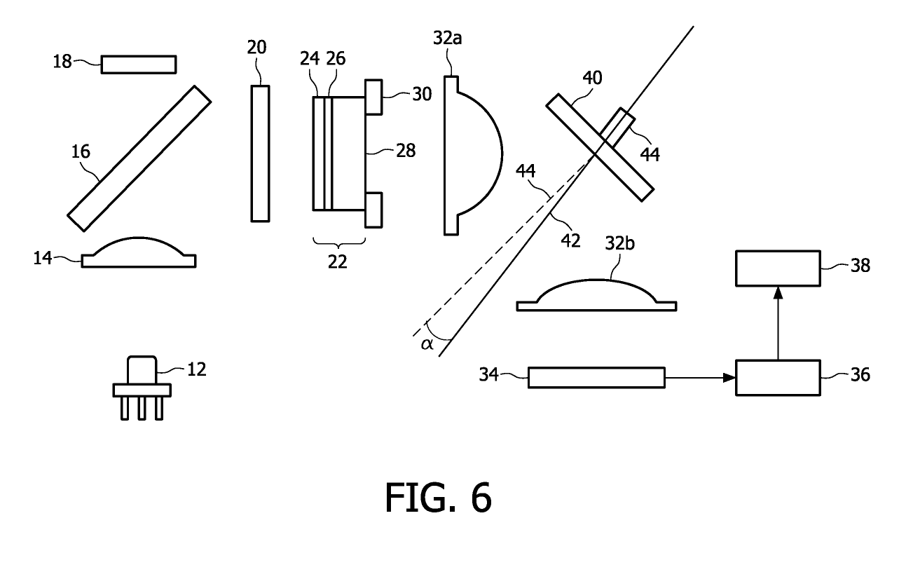

FIG. 6 is a schematic view of a multispot scanning microscope according to a second embodiment of the invention. The general setup of the microscope is identical to the one of the first embodiment described with reference to FIG. 3. Imaging optics 32 comprises a first lens 32a and a second lens 32b, the beam being substantially collimated in between the lenses 32a and 32b. The lenses 32a and 32b can be singlet or composite lenses. The optical axis of the second lens 32b cuts the optical axis of the first lens 32a at a right angle. A plane mirror 40 is placed at the point where the optical axes of the first lens 32a and of the second lens 32b intersect. The mirror 40 is oriented such that it deflects light coming from the first lens 32a by an angle of around 90°, so that the light is incident on the second lens 32b. The mirror 40 is supported by an axle 44 which makes it rotatable about a rotational axis 42. The rotational axis 42 is the angle bisector of the angle defined by the optical axis of the first lens 32a and the optical axis of the second lens 32b. The mirror's optical axis 44 makes an angle α with the mirror's rotational axis 42. The angle α is sufficiently small so that essentially all of the light coming from the first lens 32a is collected by the second lens 32b, independent of the mirror's angle of rotation about the rotational axis 44. For the shown arrangement it is clear that α must be smaller than 45°. The largest possible value of α depends on the numerical apertures of the lenses 32a and 32b. In practice a will be much smaller than 45°. Preferably, α is less than 5°. In contrast to the first embodiment described above, where the mirror was to be rotated back and forth, the present second embodiment allows for a continuous rotation of the mirror 40 about its rotational axis 44, whereby the mirror's optical axis 44 sweeps out a cone with opening half-angle α.

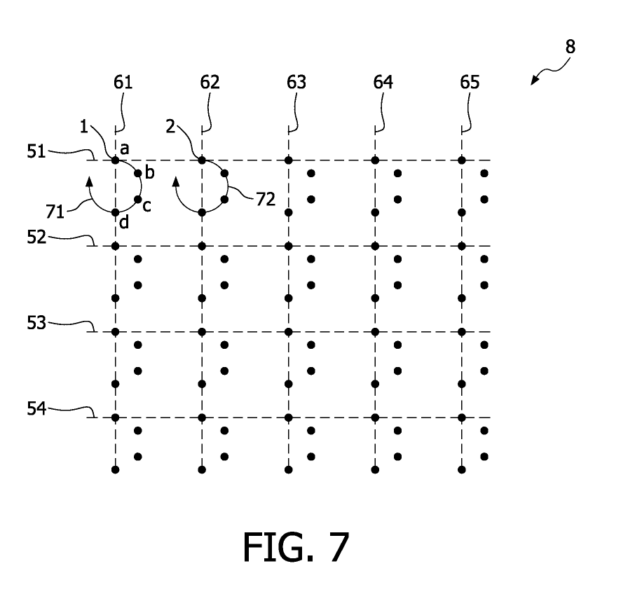

Turning now to FIG. 7, there is shown an image 8 as recorded on the image sensor 32 by means of the setup described above with reference to FIG. 6. The image 8 is the result of four successive illuminations a, b, c, and d, of the sample, resulting in the recording of four rectangular spot arrays which are mutually displaced by arcs of a circle. The first array, resulting from the first illumination, is composed of four rows 51, 52, 53, 54 and five columns 61, 62, 63, 64, 65. The array comprises a first spot 1 and a second spot 2. As the mirror 40 is rotated about its rotational axis 42, as described with reference to FIG. 6, the optical image generated on the image sensor 32, is translated along a circular path, that is, each point of the optical image is translated along a similar circular path. Thus the first spot 1 and the second spot 2 are the starting points of a first circular path 71 and a second circular path 72, respectively. Note that these paths do not cross, their radius being sufficiently small, in particular smaller than half the pitch of the array. Accordingly no part of the image sensor 32 is exposed to a light spot more than once during a single exposure phase of sensor.

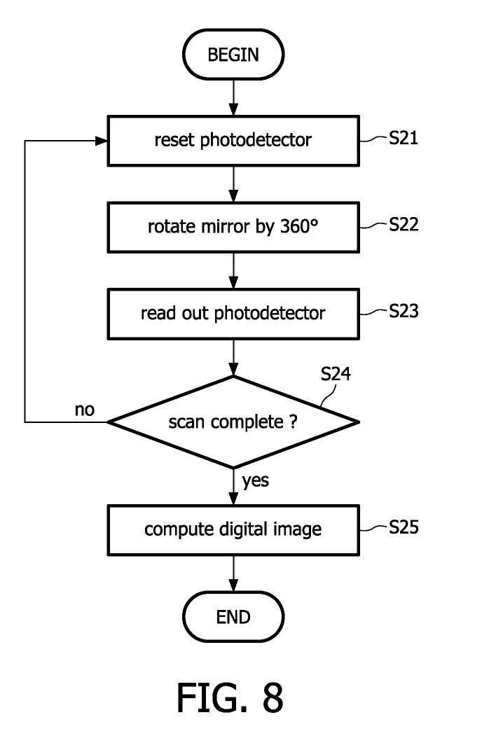

Referring to FIG. 8, there is shown a flow chart of the method according to the embodiment discussed above with reference to FIG. 6 and FIG. 7. In a first step S21, the image sensor 32 is reset, so that it is thereafter ready to record a new image. Thereby an exposure phase of the image sensor is initiated. In a subsequent step S22 the mirror 44 shown in FIG. 6 rotates at a constant angular velocity about its rotational axis 44, making a rotation of 360°. At the same time, the laser 12 emits a total of six light pulses at regular intervals, thereby generating six mutually displaced arrays of light spots on the image sensor 32. In a subsequent step S23, the image 8 recorded on the image sensor 32 is read out, whereby the exposure phase is terminated. Finally, in a subsequent decision step S24, it is determined whether the scan of the sample is complete or not. If the scan is not found to be complete, the process returns to step S21 of resetting the photodetector. If however the scan is found to be complete, a digital image of the sample is computed using image data collected from the image sensor 32 during the preceding cycles.

Although the present invention has been described above with reference to specific embodiment, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, etc do not preclude a plurality. Reference signs in the claims are provided merely as a clarifying example and shall not be construed as limiting the scope of the claims in any way.

1. A method of imaging a sample (26) with a scanning microscope, comprising the steps of:
initiating an exposure phase of a detector (34);
generating an optical image of the sample on the detector; and
terminating the exposure phase;
wherein the step of generating the optical image comprises a step of:
displacing the optical image on the detector.

2. The method as claimed in claim 1, wherein the step of displacing the optical image comprises a step of:
displacing the optical image on the detector along a straight line or along an arc of a circle or along a closed line.

3. The method as claimed in claim 1, wherein the step of displacing the optical image comprises a step of:
moving a mirror (40) situated on an optical path from the sample (26) to the detector (34).

4. The method as claimed in claim 1, wherein the step of generating an optical image comprises a step of:
simultaneously generating a first light spot (1) and a second light spot (2) within the sample (26);
and wherein the step of displacing the optical image is further characterized in that the first light spot generates a first trace (71) on the detector (34) and the second light spot generates a second trace (72) on the detector (34) such that the trace of the first light spot and the trace of the second light spot do not cross.

5. The method as claimed in claim 1, wherein the step of generating an optical image comprises a step of:
illuminating the sample (26) using light pulses.

6. An imaging system for a scanning microscope, the imaging system comprising:
a detector (34);
a lens system (32) for generating on the detector an optical image of a sample (26); and
image displacement means for displacing the optical image on the detector during an exposure phase of the detector.

7. The imaging system as claimed in claim 6, wherein the image displacement means comprise a rotatable mirror (40) situated on an optical path from the sample (26) to the detector (34).

8. The imaging system as claimed in claim 7, wherein the mirror's rotational axis (44) and the mirror's optical axis (42) cut each other at a right angle.

9. The imaging system as claimed in claim 7, wherein the mirror's rotational axis (44) and the mirror's optical axis (42) cut each other at a positive angle of less than 5°.

10. A scanning microscope comprising an imaging system as claimed in claim 8.

11. The scanning microscope as claimed in claim 10, further comprising means for generating an array of light spots focused in the sample.
